(19) United States
(12) Patent Application Publication
(10) Pub. No.: US 2013/0019451 A1
(43) Pub. Date: Jan. 24, 2013

(54) POLYAMIDE RESIN COMPOSITION FOR SLIDING PART, SLIDING PART, AND METHOD FOR PRODUCING A SLIDING PART AS WELL AS METHOD FOR PRODUCING AN AUTOMOBILE

(71) Applicants: Shigekazu Okamura, Ube-shi, (JP); Hiroaki Fujii, Ube-shi (JP)

(72) Inventors: Shigekazu Okamura, Ube-shi, (JP); Hiroaki Fujii, Ube-shi (JP)

(73) Assignee: Ube Industries, Ltd., Yamaguchi (JP)

(21) Appl. No.: 13/637,511

(22) PCT Filed: Mar. 23, 2011
(86) PCT No.: PCT/JP2011/056942

§ 371 Date: Sep. 26, 2012

(30) Foreign Application Priority Data
Mar. 26, 2010 (JP) 2010-072086

(51) Int. Cl. C08L 77/06; C08K 7/14; B23P 11/00

(52) U.S. Cl. 29/428; 525/184; 525/179; 525/90; 525/92 B; 524/514; 524/505

(57) ABSTRACT

A polyamide resin composition for sliding part and a sliding part, each being prevented from shrinking both in the MD direction and in the TD direction (having excellent dimensional stability as well as excellent dimensional stability when water is absorbed into the resin) and having excellent impact resistance, a method for producing the sliding part, and a method for producing an automobile using the sliding part. The polyamide resin composition for sliding part includes a polyamide resin (component A) and a styrene polymer (component B), wherein the component B has a deflection temperature under load of 140 to 280° C., and the weight ratio of the component A to the component B (A/B) is 95/5 to 77/23.

### FIELD OF THE INVENTION

The present invention relates to a polyamide resin composition for sliding part, a sliding part, and a method for producing a sliding part as well as a method for producing an automobile.

### BACKGROUND ART

A polyamide resin exhibits excellent properties as an engineering plastic, and therefore is utilized in the production of various machines and parts, such as the production of automobiles, the production of machines, and the production of electric and electronic parts. The polyamide resin is excellent particularly in mechanical properties and wear resistance, and hence widely used as a molding material for sliding parts, such as a gear, a cam, and a bearing.

Patent document 1 has a description about an electric power steering (EPS) gear, and, from the viewpoint of the improvement of wear resistance of a part, such as a gear, patent document 1 proposes a polyamide resin composition comprising a polyamide resin and glass fibers in specific amounts.

Patent document 2 discloses a technique for reducing the dimensional change of a polyamide resin composition due to water absorption by using the polyamide resin composition comprising polyamide and polypropylene.

Patent document 3 has a description of a polyamide resin composition using a polyamide resin, a modified polyphenylene ether polymer, a syndiotactic polystyrene polymer, and a modified ethylene-propylene copolymer.

Patent document 4 discloses a polystyrene resin composition characterized by containing 0.5 to 10.0 parts by weight of polyphenylene ether modified with a specific acid, relative to 100 parts by weight of the total of a styrene polymer (SPS) having a syndiotactic structure in an amount of 9.0 to 90.0% by weight, a rubbery elastomer in an amount of 1.0 to 50.0% by weight, and polyamide in an amount of 9.0 to 90.0% by weight.

### CITED REFERENCES

### Patent Documents

Patent document 1: WO2006/054774
Patent document 2: Japanese Unexamined Patent Publication No. 2004-052840
Patent document 3: Japanese Unexamined Patent Publication No. 2000-063663
Patent document 4: Japanese Unexamined Patent Publication No. Hei 08-311196

### DISCLOSURE OF THE INVENTION

### Problems to be Solved by the Invention

In recent years, various machines and parts are required to be improved in performance, and particularly, sliding parts, such as an electric power steering (EPS) gear, are required to be improved in performance. And therefore the polyamide resin shaped articles are needed to have more excellent dimensional stability as well as more excellent dimensional stability when water is absorbed into the polyamide resin and higher impact resistance than ever conventional. For example, when a polyamide resin is used in a gear for automobile, particularly in a sliding part, such as an electric power steering (EPS) gear, the gear, for example, swells due to water absorption or the like and hence changes in dimension, so that the engagement effect of the gear with another member is reduced. Therefore, there are disadvantages in that it is necessary to process the gear smaller by the increase of dimension expected from the above-mentioned change in dimension of the gear, and that a backlash adjusting mechanism for making up for the reduction of the engagement effect must be installed in an automobile having a gear incorporated, and thus such disadvantages cause the production cost to increase. The dimensional stability as well as the dimensional stability when water is absorbed into the resin and the impact resistance of the sliding part improve the gear itself in precision from the viewpoint of improving the steering performance, and particularly for the reason that a dimensional change of the gear tooth thickness on the pitch diameter must be reduced, recently, the member is particularly needed to be reduced in shrinkage in the MD direction and the TD direction and improved in impact resistance.

The polyamide resin compositions described in patent documents 1 to 3 cannot meet the needs to reduce shrinkage of the sliding part in the MD direction and the TD direction and to improve the impact resistance of the sliding part.

Further, in the polyamide resin composition disclosed in patent document 4, from the viewpoint of improving the mechanical strength of SPS, a polyamide resin and polyphenylene ether modified with a specific acid are added to the SPS, but, from the viewpoint of securing the SPS mechanical strength improvement effect and the stability to acids and alkalis, it is recommended that the amount of the polyamide incorporated into the composition should be 80% by weight or less, based on the total weight of the resins. Accordingly, in the working Examples of patent document 4, the SPS is incorporated in an amount as large as 40 to 45% by weight and the polyamide resin is incorporated in an amount of only 50% by weight, based on the total weight of the resins.

Therefore, with respect to the sliding part using a polyamide resin, from the viewpoint of surely achieving the marked reduction of the shrinkage in the MD direction and the TD direction and the anisotropy and excellent impact resistance and excellent wear resistance, which are recently required for the sliding part, the technical concept disclosed in patent document 4 is not satisfactory.

A task of the present invention is to provide a polyamide resin composition for sliding part and a sliding part, each being prevented from shrinking both in the MD direction and in the TD direction (having excellent dimensional stability as well as excellent dimensional stability when water is absorbed into the resin) and having excellent impact resistance, a method for producing the sliding part, and a method for producing an automobile using the sliding part.

### Means to Solve the Problems

The present invention has the following contents (1) to (4).

(1) A polyamide resin composition for sliding part, comprising a polyamide resin (component A) and a styrene polymer (component B),

the component B having a deflection temperature under load of 140 to 280° C.,

the weight ratio of the component A to the component B (A/B) being 95/5 to 77/23.

(2) A sliding part obtainable by shaping the polyamide resin composition for sliding part according to item (1) above.

(3) A method for producing a sliding part, comprising shaping a polyamide resin composition,

the polyamide resin composition having an initial shrinkage factor of 0.2 to 1.2 in the MD direction and an initial shrinkage factor of 1.0 to 1.4 in the TD direction.

(4) A method for producing an automobile, comprising incorporating a sliding part obtainable by the method according to item (3) above into a sliding apparatus.

### Effect of the Invention

In the present invention, there can be provided a polyamide resin composition for sliding part and a sliding part, each being prevented from shrinking both in the MD direction and in the TD direction (having excellent dimensional stability as well as excellent dimensional stability when water is absorbed into the resin) and having excellent impact resistance, a method for producing the sliding part, and a method for producing an automobile using the sliding part.

### BEST MODE FOR CARRYING OUT THE INVENTION

### [Polyamide Resin Composition]

The polyamide resin composition of the present invention (hereinafter, frequently referred to as “polyamide resin composition”) is a polyamide resin composition for sliding part, which comprises a polyamide resin (component A) and a styrene polymer (component B), wherein the component B has a deflection temperature under load of 140 to 280° C., and the weight ratio of the component A to the component B (A/B) is 95/5 to 77/23.

### (Component A)

Component A is preferably obtained by, e.g., condensation polymerization of a diamine and a dicarboxylic acid, self condensation polymerization of an w-aminocarboxylic acid, or ring-opening polymerization of a lactam. Component A has a satisfactory molecular weight. And, from the viewpoint of obtaining a sliding part, especially a gear, particularly an EPS gear, having satisfactory mechanical properties and wear resistance,

component A preferably has a limiting PV value of 20 to 1,000 MPa·cm/sec, more preferably 30 to 700 MPa·cm/sec, further preferably 40 to 600 MPa·cm/sec,

preferably has a coefficient of dynamic friction of 0.001 to 0.7, more preferably 0.005 to 0.6, further preferably 0.01 to 0.5, and

preferably has an impact resistance of 20 to 300 J/m, more preferably 30 to 250 J/m, further preferably 40 to 200 J/m.

The above-mentioned physical properties (limiting PV value, coefficient of dynamic friction, and impact strength) can be achieved by controlling the below-mentioned preferred formulation of the raw materials for condensation polymerization and number average molecular weight in the range of common general technical knowledge with respect to component A.

From the viewpoint of obtaining a sliding part, especially a gear, particularly an EPS gear, having satisfactory mechanical properties and wear resistance, as specific examples of the diamines, preferred are aliphatic diamines, such as tetramethylenediamine, hexamethylenediamine, undecamethylenediamine, dodecamethylenediamine, 2,2,4-trimethylhexamethylenediamine, and 5-methylnonamethylenediamine; alicyclic diamines, such as 1,3-bisaminomethylcyclohexane, 1,4-bisaminomethylcyclohexane, bis-p-aminocyclohexylmethane, bis-p-aminocyclohexylpropane, and isophoronediamine; and aromatic diamines, such as m-xylylenediamine and p-xylylenediamine, more preferred is tetramethylenediamine and/or hexamethylenediamine, and further preferred is hexamethylenediamine.

From the viewpoint of obtaining a sliding part, especially a gear, particularly an EPS gear, having satisfactory mechanical properties and wear resistance, as specific examples of the dicarboxylic acids, preferred are aliphatic dicarboxylic acids, such as adipic acid, suberic acid, azelaic acid, sebacic acid, and dodecanedioic acid; alicyclic dicarboxylic acids, such as 1,3-cyclohexanedicarboxylic acid and 1,4-cyclohexanedicarboxylic acid; and aromatic dicarboxylic acids, such as terephthalic acid, isophthalic acid, naphthalenedicarboxylic acid, and a dimer acid, more preferred are adipic acid, terephthalic acid and/or isophthalic acid, and further preferred is adipic acid.

From the viewpoint of obtaining a sliding part, especially a gear, particularly an EPS gear, having satisfactory mechanical properties and wear resistance, with respect to the ω-aminocarboxylic acid, specifically, ε-aminocaproic acid, 11-aminoundecanoic acid and/or 12-aminododecanoic acid are preferred, and ε-aminocaproic acid is more preferred.

From the viewpoint of obtaining a sliding part, especially a gear, particularly an EPS gear, having satisfactory mechanical properties and wear resistance, with respect to the lactam, ε-caprolactam, enanthlactam and/or ω-laurolactam are preferred, and ε-caprolactam is more preferred.

With respect to component A, there can be used any of a polyamide homopolymer, a copolymer, and a mixture of the homopolymer and/or copolymer, each of which is obtained by subjecting the above-mentioned diamine and dicarboxylic acid, or ω-aminocarboxylic acid, or lactam individually or in the form of a mixture to condensation polymerization or other polymerization.

With respect to component A having the above-mentioned preferred formulation and physical properties, preferred is at least one compound selected from the group consisting of polyamide 6, polyamide 46, polyamide 66, polyamide 11, polyamide 12, polyamide 610, polyamide 612, polyamide 6/66, polyamide 6/612, polyamide 6MXD (wherein MXD indicates a m-xylylenediamine component), polyamide 66/6T (wherein T indicates a terephthalic acid component), and polyamide 6T/6I (wherein I indicates an isophthalic acid component), and, from the viewpoint of obtaining excellent mechanical properties and a good balance between the mechanical properties and moldability and reducing the cost, more preferred is at least one compound selected from the group consisting of polyamide 6, polyamide 66, polyamide 11, polyamide 12, polyamide 6/66, polyamide 66/6T, and polyamide 6T/6I, and further preferred is at least one compound selected from the group consisting of polyamide 6 and polyamide 66.

The designations for component A are in accordance with the symbols described in JIS K6920-1 indicating the chemical structures of homopolyamide materials and copolyamide materials.

With respect to the number average molecular weight of component A, from the viewpoint of surely obtaining the polyamide resin composition having excellent mechanical properties and a melt viscosity required for achieving excellent moldability, there can be used component A having a number average molecular weight preferably in the range of from 10,000 to 50,000, more preferably from 13,000 to 30,000.

### (Component B)

Component B is a styrene polymer, and, from the viewpoint of improving the heat resistance and surely achieving excellent dimensional stability, component B has a deflection temperature under load of 140 to 280° C., preferably 150 to 280° C., more preferably 160 to 280° C., further preferably 170 to 280° C.

The styrene polymer means a polymer comprising structural units derived from a styrene monomer or a styrene-based monomer which is a phenyl group or substituted phenyl of styrene, and preferred are polystyrene, poly(alkylstyrene), poly(halogenated styrene), poly(halogenated alkylstyrene), poly(alkoxystyrene), poly(vinyl benzoate), poly(phenylstyrene), poly(vinylnaphthalene), poly(vinylstyrene), hydrogenated polymers thereof, mixtures thereof, and copolymers comprised mainly of them.

Examples of poly(alkylstyrene) include poly(methylstyrene), poly(ethylstyrene), poly(isopropylstyrene), and poly(tert-butylstyrene). Examples of poly(halogenated styrene) include poly(chlorostyrene), poly(bromostyrene), and poly(fluorostyrene).

Examples of poly(halogenated alkylstyrene) include poly(chloromethylstyrene).

Examples of poly(alkoxystyrene) include poly(methoxystyrene) and poly(ethoxystyrene).

Preferred examples of styrene polymers include polystyrene, poly(p-methylstyrene), poly(m-methylstyrene), poly(p-tert-butylstyrene), poly(p-chlorostyrene), poly(m-chlorostyrene), poly(p-fluorostyrene), hydrogenated polymers thereof, and copolymers comprising the above structural units.

The styrene polymers can be used individually or in combination of two or more.

The deflection temperature under load is a yardstick for the heat resistance of the styrene polymer, and, when the styrene polymer is preferably a styrene polymer having a syndiotactic structure (hereinafter, frequently referred to as “SPS”), the styrene polymer can achieve a deflection temperature under load in the above-mentioned preferred range.

The deflection temperature under load is defined as a temperature, as measured in accordance with ASTM D-648, at which a test piece having a size of length: 5 inches×width: ½ inch×thickness: ½ inch, which is obtained by molding at a mold temperature of 150° C., is deflected by 0.25 mm when the temperature of the test piece is elevated from room temperature at a temperature elevation rate of 2° C./min while applying a stress of 0.46 MPa to the test piece.

The term “syndiotactic structure” for SPS means a stereostructure of a syndiotactic structure, namely, a stereostructure in which side chains, such as a phenyl group and a substituted phenyl group, are positioned alternately in different directions with respect to the principal chain formed from a carbon-carbon bond.

A method for producing SPS is disclosed in, for example, Japanese Unexamined Patent Publication No. 2009-68022.

SPS is commercially available, for example, from Idemitsu Kosan Co., Ltd. in the trade named of “XAREC”.

The tacticity of SPS is quantitatively determined by a nuclear magnetic resonance method using isotopic carbon (¹³C-NMR method). The tacticity determined by a ¹³C-NMR method can be indicated by the ratio of a plurality of continuous units present in the polymer, for example, dyad for two units, triad for three units, or pentad for five units.

From the viewpoint of preventing the lowering of thermal properties and mechanical properties, component B indicates polystyrene, poly(alkylstyrene), poly(halogenated styrene), poly(halogenated alkylstyrene), poly(alkoxystyrene), poly(vinyl benzoate), poly(phenylstyrene), poly(vinylnaphthalene), or poly(vinylstyrene), a hydrogenated polymer thereof, a mixture thereof, or a copolymer comprised mainly of them, each having syndiotacticity which is generally racemic dyad in an amount of 75% or more, preferably 85% or more, or racemic pentad in an amount of 30% or more, preferably 50% or more.

From the viewpoint of preventing the reduction of thermal properties or mechanical properties of the obtained composition or shaped article, the weight average molecular weight of component B is preferably 10,000 or more, more preferably 50,000 or more, and preferably 400,000 or less, more preferably 300,000 or less, further preferably 10,000 to 400,000, still further preferably 50,000 to 300,000.

### (Component C)

From the viewpoint of improving the limiting PV value indicating an impact resistance and sliding properties, it is preferred that the polyamide resin composition of the present invention further comprises a thermoplastic resin (component C) obtained by copolymerizing a monomer derived from styrene and a monomer derived from an olefin and/or a monomer derived from a conjugated diene, provided that component B is excluded from component C.

Component C is called a styrene elastomer resin, and it is considered that component C is compatible with component B in the polyamide resin composition to form a core/shell structure in which component C constitutes a core and component B constitutes a shell, and a synergy between components B and C remarkably improves the limiting PV value indicating an impact resistance and sliding properties of the polyamide resin composition.

From the viewpoint of improving the limiting PV value indicating an impact resistance and sliding properties of the polyamide resin composition, component C is preferably at least one compound selected from the group consisting of a styrene-butadiene copolymer (SBR), a hydrogenated styrene-butadiene block copolymer (SEB), a styrene-butadiene-styrene block copolymer (SBS), a hydrogenated styrene-butadiene-styrene block copolymer (SEBS), a styrene-isoprene block copolymer (SIR), a hydrogenated styrene-isoprene block copolymer (SEP), a hydrogenated styrene-isoprene-styrene block copolymer (SEP), a styrene-isoprene-styrene block copolymer (SIS), a styrene-butadiene random copolymer, a hydrogenated styrene-butadiene random copolymer, a styrene-ethylene-propylene random copolymer, a styrene-ethylene-butylene random copolymer, a methyl methacrylate-butadiene-styrene copolymer (MBS), an octyl acrylate-butadiene-styrene copolymer (MABS), and an alkyl acrylate-butadiene-acrylonitrile-styrene copolymer (AABS), and is more preferably SBR, SER, SBS, SEBS, SIR, SEP, SIS, SEPS, a copolymer containing styrene units, or a copolymer obtained by modifying the above copolymer, further preferably SEPS, SEBS, or SEP, further preferably SEPS.

With respect to component C, there can be used a commercially available thermoplastic elastomer representatively including SEPTON, manufactured by Kuraray Co., Ltd., which is a block copolymer basically of a diblock or triple block comprised of a polystyrene block and an elastomer block having a flexible polyolefin structure.

### (Component D)

From the viewpoint of rendering components A and B compatible with each other to improve the limiting PV value indicating an impact resistance and sliding properties, it is preferred that the polyamide resin composition of the present invention further comprises at least one compound (component D) selected from the group consisting of a styrene-polyamide block copolymer, a styrene-glycidyl methacrylate copolymer, a styrene-maleic anhydride copolymer, a maleic anhydride-modified styrene block copolymer, a maleic anhydride-modified polyphenylene ether, a maleic anhydride-modified SPS, and a fumaric acid-modified polyphenylene ether, provided that component B is excluded from component D.

Component D is a thermoplastic resin component for rendering components A and B compatible with each other, and the addition of component D to components A and B makes it possible to finely disperse component B in component A.

From the viewpoint of avoiding the lowering of the mechanical properties caused due to lacks of the dispersibility of component B in component A and the strength of the interface between component B and component A, component D is preferably a styrene-polyamide block copolymer, a styrene-glycidyl methacrylate copolymer, a styrene-maleic anhydride copolymer, a maleic anhydride-modified styrene block copolymer, a maleic anhydride-modified polyphenylene ether, a maleic anhydride-modified SPS, or a fumaric acid-modified polyphenylene ether, further preferably a fumaric acid-modified polyphenylene ether (hereinafter, polyphenylene ether is frequently referred to as “PPE”).

### (Component E)

From the viewpoint of achieving excellent dimensional stability as well as excellent dimensional stability when water is absorbed into the polyamide resin, it is preferred that the polyamide resin composition of the present invention further comprises glass fibers (component E).

Component E is preferably bound by a known binder comprised mainly of, e.g., an acrylic resin, an epoxy resin, or an urethane resin, and preferably bound by a binder comprised mainly of an acrylic resin or an epoxy resin.

Further, component E, which has been subjected to preliminary treatment with a coupling agent, such as an isocyanate compound, an organic silane compound, an organic titanate compound, an organoborane compound, or an epoxy compound, is preferably used because it is expected that the obtained shaped article is further improved in mechanical properties.

From the viewpoint of achieving excellent dimensional stability as well as excellent dimensional stability when water is absorbed into the polyamide resin, component E preferably has a weight average fiber length of 100 to 1,000 μm, more preferably 150 to 600 μm, further preferably 200 to 500 μm, and preferably has an average fiber diameter of 3 to 20 μm, more preferably 4 to 15 μm, further preferably 5 to 13 μm.

### (Other Components)

In the polyamide resin composition of the present invention, a reinforcing agent or a filler in various forms, such as a fibrous form, a powdery form, a flake form, or a mat form, can be added in such an amount that the moldability and physical properties of the polyamide resin composition are not sacrificed.

Specific examples of the reinforcing agents and fillers include inorganic and metal fibers, such as carbon fibers, silica fibers, silica alumina fibers, alumina fibers, zirconia fibers, boron nitride fibers, silicon nitride fibers, basic magnesium sulfate fibers, boron fibers, stainless steel fibers, aluminum, titanium, copper, brass, and magnesium; organic fibers, such as polyester, polyacrylonitrile, and cellulose; metal powder, such as copper, iron, nickel, zinc, tin, stainless steel, aluminum, gold, and silver; fumed silica, aluminum silicate, calcium silicate, silicic acid, water-containing calcium silicate, water-containing aluminum silicate, glass beads, carbon black, quartz powder, talc, mica, titanium oxide, iron oxide, zinc oxide, calcium carbonate, magnesium carbonate, magnesium oxide, calcium oxide, magnesium sulfate, potassium titanate, and diatomaceous earth, but the reinforcing agent and filler are not limited to these materials.

When the reinforcing agent or filler is in a fibrous form, one having an average fiber diameter of 0.1 to 30 μm and a fiber length/fiber diameter ratio of 10 or more is preferably used.

Further, these reinforcing agents and fillers may be those which have been subjected to surface treatment with, e.g., a known silane coupling agent or titanate coupling agent.

These reinforcing agents and fillers may be used individually or in combination of two or more.

In the polyamide resin composition of the present invention, if necessary, at least one additive can be added, and examples of additives include:

antioxidants, e.g., organic antioxidants, such as a hindered phenol, a hydroquinone, a thioether, a phosphite, an amine, and a substituted compound thereof, inorganic antioxidants, e.g., copper compounds, such as copper(I) (cuprous) chloride, copper(II) (cupric) chloride, copper(I) bromide, copper(II) bromide, copper(I) iodide, copper(II) iodide, copper(II) sulfate, copper(II) nitrate, copper(II) phosphate, copper(II) pyrophosphate, copper(I) acetate, copper(II) acetate, copper(II) salicylate, copper(II) stearate, and copper(II) benzoate, halogenated alkali metal compounds, such as potassium iodide, lithium chloride, lithium bromide, lithium iodide, lithium fluoride, sodium chloride, sodium bromide, sodium iodide, potassium chloride, potassium bromide, potassium iodide, and potassium fluoride, and cerium oxide, titanium oxide, and zinc oxide, preferably copper(I) iodide and/or potassium iodide antioxidant, more preferably copper(I) iodide and potassium iodide antioxidants;

discoloration preventing agents for preventing discoloration caused due to a heat-resistance improving agent, such as melamine, cyanuric acid, dimethylolurea, 2-mercaptobenzimidazole, benzoguanamine, and guanidyl sulfamate, preferably melamine;

heat stabilizers such as organotin, lead, or metal soap;

ultraviolet light stabilizers, such as resorcinol, a salicylate, benzotriazole, and benzophenone;

release agents, such as stearic acid and a salt thereof, and stearyl alcohol;

inorganic flame retardants, such as red phosphorus, tin oxide, zirconium hydroxide, barium metaborate, aluminum hydroxide, magnesium hydroxide, calcium hydroxide, and hydrotalcite;

organic flame retardants such as halogen, phosphate, melamine, or cyanuric acid organic flame retardants; auxiliaries for flame retardant, such as antimony trioxide;

antistatic agents, such as sodium dodecylbenzenesulfonate, polyalkylene glycol, and an alkylbetaine; and a crystallization accelerator, a dye, and a pigment.

### (Formulation)

In the polyamide resin composition of the present invention, from the viewpoint of securing the mechanical properties and wear resistance at basic levels for the use as a sliding part, component A is preferably present in an amount of 30 to 95% by weight, more preferably 35 to 80% by weight, further preferably 40 to 65% by weight, based on 100% by weight of the whole of the thermoplastic resin components in the polyamide resin composition.

The organic fibers which can be incorporated as a reinforcing agent are not included in the thermoplastic resin components in the polyamide resin composition.

In the polyamide resin composition of the present invention, from the viewpoint of achieving excellent dimensional stability as well as excellent dimensional stability when water is absorbed into the polyamide resin, the weight ratio of component A to component B (A/B) is 95/5 to 77/23, preferably 90/10 to 77.5/22.5, more preferably 85/25 to 77.5/22.5, further preferably 82/18 to 77.5/22.5, further preferably 80/20 to 79/21.

In the polyamide resin composition of the present invention, from the viewpoint of achieving excellent limiting PV value and coefficient of friction, the weight ratio of component B to component C (B/C) is preferably 100/0 to 50/50, more preferably 99/1 to 50/50, further preferably 90/10 to 60/40, further preferably 80/20 to 60/40, further preferably 70/30 to 65/35.

In the polyamide resin composition of the present invention, from the viewpoint of achieving excellent compatibility between component A and component B, the weight ratio of the sum of component A and component B to component D {(A+B)/D} is preferably 100/0 to 50/50, more preferably 95/5 to 60/40, further preferably 92/8 to 80/20, further preferably 91/9 to 85/25.

In the polyamide resin composition of the present invention, from the viewpoint of further enhancing the dimensional stability as well as the dimensional stability when water is absorbed into the polyamide resin, the weight ratio of component E to the sum of components A, B, C, and D of the polyamide resin composition {E/(A+B+C+D)} is preferably 10/90 to 50/50, more preferably 15/85 to 40/60, further preferably 20/80 to 30/70.

In the polyamide resin composition of the present invention, from the viewpoint of achieving excellent dimensional stability as well as excellent dimensional stability when water is absorbed into the polyamide resin, it is preferred that component A is present in an amount of 69.45 to 85% by weight, component B is present in an amount of 10 to 25% by weight, and component D is present in an amount of 5 to 20% by weight, based on 100% by weight of the whole of components A, B, and D.

In the polyamide resin composition of the present invention, from the viewpoint of further improving the dimensional stability as well as the dimensional stability when water is absorbed into the polyamide resin, it is preferred that component A is present in an amount of 50 to 75% by weight, component B is present in an amount of 10 to 20% by weight, component D is present in an amount of 5 to 10% by weight, and component E is present in an amount of 10 to 30% by weight, based on 100% by weight of the whole of components A, B, D, and E.

In the polyamide resin composition of the present invention, from the viewpoint of further improving the dimensional stability as well as the dimensional stability when water is absorbed into the polyamide resin, it is preferred that component A is present in an amount of (52.09×100/99.59) to 75% by weight, component B is present in an amount of 10 to (15.06×100/99.59) % by weight, component D is present in an amount of 5 to (7.50×100/99.59) % by weight, and component E is present in an amount of 10 to (25.00×100/99.59) % by weight, based on 100% by weight of the whole of components A, B, D, and E.

### (Production Method)

The polyamide resin composition of the present invention can be produced by melt-kneading a polyamide resin (component A), a styrene polymer (component B), and, if necessary, component C, component D and/or glass fibers (component E) in a proportion in the predetermined range by a known method using a known melt-kneader, such as a single-screw or twin-screw kneading extruder or a Banbury mixer. When melt-kneading the components of the composition, if necessary, the above-mentioned additive or additives are added to the composition.

### [Sliding Part]

The polyamide resin composition of the present invention can be shaped, using a known shaping method, such as an extrusion method, a blow molding method, or an injection molding method, into a shaped article for use as a sliding member, such as a gear, a pulley, a cam, or a bearing in various shapes for automobile or machine, preferably a gear, more preferably an EPS gear. The polyamide resin composition of the present invention can be advantageously used in the production of a sliding member, such as a gear, a pulley, a cam, or a bearing for automobile or machine, more preferably a gear, particularly an EPS gear.

With respect to the shaped article obtainable by shaping the polyamide resin composition of the present invention, preferred are a gear, a pulley, a cam, and a bearing, in which the effect of the present invention is remarkable, that is, the dimensional stability as well as the dimensional stability when water is absorbed into the polyamide resin are excellent, more preferred is a gear, and a gear for automobile is more preferred, and an EPS gear is further preferred.

### [Method for Producing a Sliding Part]

The method for producing a sliding part of the present invention is a method for producing a sliding part, which comprises shaping a polyamide resin composition, wherein the polyamide resin composition has an initial shrinkage factor of 0.2 to 1.2 in the MD direction and an initial shrinkage factor of 1.0 to 1.4 in the TD direction, preferably has an initial shrinkage factor of 0.2 to 0.4 in the MD direction and an initial shrinkage factor of 1.0 to 1.2 in the TD direction, more preferably has an initial shrinkage factor of 0.2 to 0.35 in the MD direction and an initial shrinkage factor of 1.0 to 1.2 in the TD direction.

In this case, in the method for producing a sliding part, the polyamide resin composition preferably has an anisotropy value of 0 to 5, more preferably 0 to 4, further preferably 0 to 3.8.

When using the polyamide resin composition having the above-mentioned initial shrinkage factors in the MD direction and the TD direction and preferably having the above-mentioned anisotropy value, the following advantages are obtained. The polyamide resin composition, for example, swells due to water absorption or the like and hence changes in dimension, so that the engagement effect of the sliding part, e.g., a gear with another member is reduced. However, by using the above-mentioned polyamide resin composition, there may be no need to process the sliding part smaller by the increase of dimension expected from the above-mentioned change in dimension of the sliding part. Further, there may be no need to install a backlash adjusting mechanism for making up for the reduction of the engagement effect in, for example, an automobile having the sliding part incorporated. Thus, the causes of increase of the cost production can be reduced.

With respect to the method for shaping the polyamide resin composition, for example, an injection molding method, an injection compression molding method, a compression molding method, an extrusion method, and a blow molding method are preferred.

With respect to the polyamide resin composition having an initial shrinkage factor of 0.2 to 1.2 in the MD direction and an initial shrinkage factor of 1.0 to 1.4 in the TD direction, preferably an initial shrinkage factor of 0.2 to 0.4 in the MD direction and an initial shrinkage factor of 1.0 to 1.2 in the TD direction, more preferably an initial shrinkage factor of 0.2 to 0.35 in the MD direction and an initial shrinkage factor of 1.0 to 1.2 in the TD direction, the polyamide resin composition of the present invention is preferred.

### [Method for Producing an Automobile]

The method for producing an automobile of the present invention is a method for producing an automobile, which comprises incorporating into a sliding apparatus a sliding part obtainable by the above-described method for producing a sliding part of the present invention.

With respect to the step of incorporating a sliding part obtainable by the method for producing a sliding part of the present invention into a sliding apparatus, for example, in an electric power steering apparatus, there is a system directly utilizing the driving force of an electric motor as an assist for steering, and a sliding part obtained by the method for producing a sliding part of the present invention, e.g., an electric power steering gear or a worm wheel has an role of using the driving force of a motor through the part to assist the steering, and they are appropriately incorporated by each assist method to produce an automobile.

When the polyamide resin composition having the above-mentioned anisotropy value is used in the step of incorporating a sliding part obtainable by the method for producing a sliding part of the present invention into a sliding apparatus, the following advantages are obtained. The polyamide resin composition, for example, swells due to water absorption or the like and hence changes in dimension, so that the engagement effect of the sliding part, e.g., a gear with another member is reduced. However, by using the above-mentioned polyamide resin composition, there may be no need to process the sliding part smaller by the increase of dimension expected from the above-mentioned change in dimension of the sliding part in the production process for automobile. Further, there may be no need to install a backlash adjusting mechanism for making up for the reduction of the engagement effect in, for example, an automobile having the sliding part incorporated. Thus, the causes of increase of the production cost can be reduced.

### EXAMPLES

The values for physical properties of the shaped articles shown in the below-described Examples and Comparative Examples are values measured by the following measurement methods.

### [Weight Average Molecular Weight]

A weight average molecular weight was determined by gel permeation chromatography (GPC) using 1,2,4-trichlorobenzene as a solvent at 130° C.

### [Number Average Molecular Weight]

Using 96% concentrated sulfuric acid as a solvent and using an automatic viscometer, manufactured by SUNCORPORATION, a relative viscosity was measured in a water tank having a temperature controlled to be 25±0.05° C., and a number average molecular weight was determined using a conversion table for the relative viscosity and molecular weight.

### [Initial Shrinkage Factor]

The pellets obtained in each of the below-described Examples and Comparative Examples were subjected to injection molding under the molding conditions in each of the Examples and Comparative Examples using a mold for injection molding, which has formed therein a mark-off line having a length of 140 mm and a width of 30 mm, and which is used for molding a plate having an external dimension (mold dimension) such that the length is 200 mm, the width is 40 mm, and the thickness is 3 mm, to obtain a shaped article as a test specimen. Dimensions of the specimen in the MD direction and in the TD direction were measured, and a ratio of shrinkage from the mark-off line dimension of the mold was determined by making a calculation, and taken as an initial shrinkage factor.

A mark-off line dimension of the mold is such that the length (MD direction) is 140 mm, the width (TD direction) is 30 mm, and the thickness is 3 mm.

### [Anisotropy]

A ratio between the above-mentioned initial shrinkage factors in the TD direction and in the MD direction was determined as an anisotropy.

### [Dimensional Change Due to Water Absorption]

With respect to a test specimen the same as the specimen for initial molding shrinkage factor, an initial dimension was measured using a measuring microscope (MEASURING MICROSCOPE STM, manufactured by OLYMPUS CORPORATION), and then a weight was measured and the specimen was subjected to the water absorption treatment shown below.

Using a thermostat (SSE-44CI-A, manufactured by KATO Inc.) at an RH of 80% at 80° C., the specimen was subjected to treatment for 50 hours, and removed from the thermostat, and then a dimension and a weight of the resultant specimen were measured.

### [Impact Resistance]

In accordance with ASTM {standard number: D-256-73; cantilever beam (Izod type) test}, the pellets obtained in each of the Examples and Comparative Examples were subjected to injection molding under the molding conditions in each of the Examples and Comparative Examples using an injection molding mold for forming a shape of a mold dimension such that the length (MD direction) is 60.3 to 63.5 mm, the width (TD direction) is 12.7 (±0.15) mm, and the thickness is 3.0 to 12.7 mmt, obtaining a shaped article as a test specimen. The specimen was machined so that the notch angle was 45±1°, the top radius was 0.25±0.05 mm, the notch dividing the plane into two parts was perpendicular to the plane and at an angle of 2° or less, and the depth of the resin from the notch bottom was 10.16±0.05 mm, and an impact strength of the resultant specimen was measured using an Izod impact tester, manufactured by Toyo Seiki Seisaku-Sho, Ltd.

### [Limiting PV Value]

The measurement was conducted by a slide cylinder-type ring-on-plate method in accordance with JIS K7218A.

From the test specimen for initial shrinkage factor, a resin plate having a size of thickness: 3 mm×30 mm (MD direction)×30 mm (TD direction) was cut out and used.

The resin plate as a square specimen was rotated at a peripheral speed of 20 cm/sec as conducted in the test in accordance with JIS K7218A method (ring-on-plate method) using a rotating hollow cylinder of a metal ring (material: S45C; the surface of the metal ring had been abraded with sandpaper 1000#), and the pressure was automatically stepwise increased from a load of 25 kg (contact pressure: 12.5 kgf/cm²) every 10 minutes (a load of 25 kg was applied for 10 minutes, and then a load of 50 kg was applied for 10 minutes, and successively the load was increased by 25 kg), and a limiting PV value was determined from a product of the limiting pressure and the peripheral speed.

The limiting pressure means a penultimate pressure of the ultimate pressure at which the resin is melted when the pressure is stepwise increased.

### [Coefficient of Dynamic Friction]

A test the same as the test for measuring a limiting PV value was conducted, and a coefficient of dynamic friction was determined by making a calculation from a frictional resistance at the above-mentioned limiting pressure. A frictional resistance can be determined using an abrasion tester (FEM-III-EN/F) by detecting with a load cell a frictional force between the resin plate and the metal cylinder. A coefficient of dynamic friction is a value obtained by dividing a frictional resistance by a load, but the frictional resistance detecting arm used in the measurement is 10 times the metal ring radius, and therefore a coefficient of dynamic friction is 10 times the value obtained by dividing a frictional resistance by a load.

### Example 1

77.45% by weight of polyamide 66 comprising hexamethylenediamine and adipic acid (PA 66-1) (number average molecular weight: 26,000; 2026B, manufactured by Ube Industries, Ltd.) (component A), 22% by weight of a styrene polymer (SPS-1) (deflection temperature under load: 179° C.; weight average molecular weight: 230,000; XAREC 90ZC, manufactured by Idemitsu Kosan Co., Ltd.) (component B), 0.03% by weight of copper(I) iodide, 0.5% by weight of potassium iodide, and 0.02% by weight of a melamine resin were kneaded together by means of a 44-mm vented twin-screw extruder having a barrel temperature set at 285° C., and the resultant mixture was cooled and then pelletized to obtain pellets of a polyamide resin composition.

Then, the obtained pellets of the polyamide resin composition were dried at 100° C. under a reduced pressure of 10 Torrs (1,330 Pa) or less for 24 hours, and then subjected to injection molding at a cylinder temperature of 285° C. and a mold temperature of 80° C. to produce specimens for various tests. With respect to the obtained specimens, the above-described measurements and determinations were made.

The polyamide 66 (PA 66-1) used had a limiting PV value of 50 MPa·cm/sec, a coefficient of dynamic friction of 0.5, and an impact strength of 40 J/m.

### Example 2

94.45% by weight of PA 66-1 (number average molecular weight: 26,000; 2026B, manufactured by Ube Industries, Ltd.) (component A), 5% by weight of SPS-1 (deflection temperature under load: 179° C.; weight average molecular weight: 230,000; XAREC 90ZC, manufactured by Idemitsu Kosan Co., Ltd.) (component B), 0.03% by weight of copper(I) iodide, 0.5% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Example 3

69.45% by weight of PA 66-1 (number average molecular weight: 26,000; 2026B, manufactured by Ube Industries, Ltd.) (component A), 20% by weight of a styrene polymer (SPS-2) (deflection temperature under load: 189° C.; weight average molecular weight: 190,000; XAREC 130ZC, manufactured by Idemitsu Kosan Co., Ltd.) (component B), 10% by weight of fumaric acid-modified PPE (CX-1, manufactured by Idemitsu Kosan Co., Ltd.) (component D), 0.03% by weight of copper(I) iodide, 0.5% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Example 4

73.45% by weight of polyamide 66 comprising hexamethylenediamine and adipic acid (PA 66-2) (number average molecular weight: 20,000; 2020B, manufactured by Ube Industries, Ltd.) (component A), 16% by weight of SPS-1 (deflection temperature under load: 179° C.; weight average molecular weight: 230,000; XAREC 90ZC, manufactured by Idemitsu Kosan Co., Ltd.) (component B), 10% by weight of fumaric acid-modified PPE (CX-1, manufactured by Idemitsu Kosan Co., Ltd.) (component D), 0.03% by weight of copper(I) iodide, 0.5% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

The polyamide 66 (PA 66-2) used had a limiting PV value of 50 MPa·cm/sec, a coefficient of dynamic friction of 0.5, and an impact strength of 40 J/m.

### Example 5

52.09% by weight of PA 66-1 (number average molecular weight: 26,000; 2026B, manufactured by Ube Industries, Ltd.) (component A), 15% by weight of SPS-2 (deflection temperature under load: 189° C.; weight average molecular weight: 190,000; XAREC 130ZC, manufactured by Idemitsu Kosan Co., Ltd.) (component B), 7.5% by weight of fumaric acid-modified PPE (CX-1, manufactured by Idemitsu Kosan Co., Ltd.) (component D), 25% by weight of glass fibers-1 (weight average fiber length: 320 μm; average fiber diameter: 6.5 μm; binder: acrylic resin; ECS03T-289DE, manufactured by Nippon Electric Glass Co., Ltd.) (component E), 0.02% by weight of copper(I) iodide, 0.36% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Example 6

54.2% by weight of PA 66-2 (number average molecular weight: 20,000; 2020B, manufactured by Ube Industries, Ltd.) (component A), 15.5% by weight of SPS-2 (deflection temperature under load: 189° C.; weight average molecular weight: 190,000; XAREC 130ZC, manufactured by Idemitsu Kosan Co., Ltd.) (component B), 4.9% by weight of fumaric acid-modified PPE (CX-1, manufactured by Idemitsu Kosan Co., Ltd.) (component D), 25% by weight of glass fibers-2 (weight average fiber length: 398 μm; average fiber diameter: 10.5 μm; binder: urethane resin; ECS03T-249H, manufactured by Nippon Electric Glass Co., Ltd.) (component E), 0.02% by weight of copper(I) iodide, 0.36% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Example 7

49.2% by weight of PA 66-2 (number average molecular weight: 20,000; 2020B, manufactured by Ube Industries, Ltd.) (component A), 13.0% by weight of SPS-2 (deflection temperature under load: 189° C.; weight average molecular weight: 190,000; XAREC 130ZC, manufactured by Idemitsu Kosan Co., Ltd.) (component B), 5.7% by weight of SEBS (SEPTON 2104, manufactured by Kuraray Co., Ltd.) (component C), 6.7% by weight of fumaric acid-modified PPE (CX-1, manufactured by Idemitsu Kosan Co., Ltd.) (component D), 25% by weight of glass fibers-2 (weight average fiber length: 392 μm; average fiber diameter: 10.5 μm; binder: urethane resin; ECS03T-249H, manufactured by Nippon Electric Glass Co., Ltd.) (component E), 0.02% by weight of copper(I) iodide, 0.36% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Example 8

49.2% by weight of PA 66-2 (number average molecular weight: 20,000; 2020B, manufactured by Ube Industries, Ltd.) (component A), 13.0% by weight of SPS-2 (deflection temperature under load: 189° C.; weight average molecular weight: 190,000; XAREC 130ZC, manufactured by Idemitsu Kosan Co., Ltd.) (component B), 5.7% by weight of SEPS (SEPTON 2104, manufactured by Kuraray Co., Ltd.) (component C), 6.7% by weight of fumaric acid-modified PPE (CX-1, manufactured by Idemitsu Kosan Co., Ltd.) (component D), 25% by weight of glass fibers-2 (weight average fiber length: 405 μm; average fiber diameter: 10.5 μm; binder: urethane resin; ECS03T-249H, manufactured by Nippon Electric Glass Co., Ltd.) (component E), 0.02% by weight of copper(I) iodide, 0.36% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Example 9

51.2% by weight of PA 66-2 (number average molecular weight: 20,000; 2020B, manufactured by Ube Industries, Ltd.) (component A), 11.0% by weight of SPS-2 (deflection temperature under load: 189° C.; weight average molecular weight: 190,000; XAREC 130ZC, manufactured by Idemitsu Kosan Co., Ltd.) (component B), 5.7% by weight of SEPS (SEPTON 2104, manufactured by Kuraray Co., Ltd.) (component C), 6.7% by weight of fumaric acid-modified PPE (CX-1, manufactured by Idemitsu Kosan Co., Ltd.) (component D), 25% by weight of glass fibers-2 (weight average fiber length: 395 μm; average fiber diameter: 10.5 μm; binder: urethane resin; ECS03T-249H, manufactured by Nippon Electric Glass Co., Ltd.) (component E), 0.02% by weight of copper(I) iodide, 0.36% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Comparative Example 1

74.55% by weight of PA 66-1 (number average molecular weight: 26,000; 2026B, manufactured by Ube Industries, Ltd.), 25.0% by weight of SPS-1 (deflection temperature under load: 179° C.; weight average molecular weight: 230,000; XAREC 90ZC, manufactured by Idemitsu Kosan Co., Ltd.), 0.03% by weight of copper(I) iodide, 0.5% by weight of potassium iodide, and 0.02% by weight of a melamine resin were subjected to treatment by the same method as in Example 1 to obtain pellets of a polyamide resin composition, producing specimens for various tests. With respect to the obtained specimens, the above-described measurements and determinations were made.

### Comparative Example 2

79.45 Parts by mass of PA 66-2 (number average molecular weight: 26,000; 2026B, manufactured by Ube Industries, Ltd.), modified polypropylene (ZP 648, manufactured by Prime Polymer Co., Ltd.), 0.03 part by mass of copper(I) iodide, 0.5 part by mass of potassium iodide, and 0.02 part by mass of a melamine resin were subjected to treatment by the same method as in Example 1 to obtain pellets of a polyamide resin composition, producing specimens for various tests. With respect to the obtained specimens, the above-described measurements and determinations were made.

### Comparative Example 3

74.6 Parts by mass of PA 66-1 (number average molecular weight: 26,000; 2026B, manufactured by Ube Industries, Ltd.), 25 parts by mass of glass fibers-1, 0.02 part by mass of copper(I) iodide, 0.36 part by mass of potassium iodide, and 0.02 part by mass of a melamine resin were subjected to treatment by the same method as in Example 1 to obtain pellets of a polyamide resin composition, producing specimens for various tests. With respect to the obtained specimens, the above-described measurements and determinations were made.

The results of the measurements and the results of the determinations in Examples 1 to 9 and Comparative Examples 1 to 3 are shown in Table 1. The values shown at the “Impact resistance”, “Limiting PV value”, and “Coefficient of dynamic friction” in Table 1 are those obtained with respect to the polyamide resin compositions in Examples 1 to 9 and Comparative Examples 1 to 3.

TABLE 1

| | | Example 1 | Example 2 | Example 3 | Example 4 | Example 5 | Example 6 |
|---|---|---|---|---|---|---|---|
| Component A | wt % | 77.45 | 94.55 | 69.45 | 73.45 | 52.09 | 54.20 |
| | Number average molecular weight | 26000 | 26000 | 26000 | 20000 | 26000 | 20000 |
| Component B | wt % | 22.00 | 5.00 | 20.00 | 16.00 | 15.00 | 15.50 |
| | Weight average molecular weight | 230000 | 230000 | 230000 | 230000 | 200000 | 230000 |
| Component C | Resin | | | | | | |
| | wt % | | | | | | |
| Component D | Compatibilizing agent | | | m-PPE | m-PPE | m-PPE | m-PPE |
| | wt % | | | 10.00 | 10.00 | 7.50 | 4.90 |
| Component E | wt % | | | | | 25.00 | 25.00 |
| Additive | Copper(I) iodide | 0.03 | 0.03 | 0.03 | 0.03 | 0.02 | 0.02 |
| | Potassium iodide | 0.50 | 0.50 | 0.50 | 0.50 | 0.36 | 0.36 |
| | Melamine resin | 0.02 | 0.02 | 0.02 | 0.02 | 0.02 | 0.02 |
| Weight ratio A/B | | 78.00/22.00 | 95.00/5.00 | 77.65/22.34 | 82.11/17.89 | 77.64/22.36 | 77.76/22.24 |
| Weight ratio B/C | | | | | | | |
| Weight ratio (A + B)/D | | | | 89.94/10.06 | 89.94/10.06 | 89.95/10.05 | 93.43/6.57 |
| Weight ratio E/(A + B + C + D) | | | | | | 24.90/75.10 | 25.10/74.90 |
| Dimensional | MD Direction initial shrinkage factor % | 1.06 | 1.16 | 1.08 | 1.13 | 0.28 | 0.25 |
| stability | TD Direction initial shrinkage factor % | 1.35 | 2.10 | 1.28 | 1.34 | 1.04 | 1.15 |
| | Anisotropy (TD/MD) | 1.25 | 1.31 | 1.19 | 1.19 | 3.71 | 4.60 |
| | MD Direction water absorption | 0.61 | 0.80 | 0.45 | 0.49 | 0.14 | 0.16 |
| | dimensional change % | | | | | | |
| | TD Direction water absorption | 0.73 | 0.90 | 0.53 | 0.58 | 0.57 | 0.60 |
| | dimensional change % | | | | | | |

| | | | | | | |
|---|---|---|---|---|---|---|
| Impact resistance (J/m) | 32.00 | 38.00 | 101.00 | 110.00 | 56.00 | 69.00 |
| Limiting PV value (Mpa · cm/sec) | 75 | 85 | 125 | 100 | 275 | 130 |
| Coefficient of dynamic friction | 0.42 | 0.40 | 0.30 | 0.32 | 0.15 | 0.28 |

| | | | | | Comparative | Comparative | Comparative |
|---|---|---|---|---|---|---|---|
| | | Example 7 | Example 8 | Example 9 | Example 1 | Example 2 | Example 3 |
| Component A | wt % | 49.20 | 49.20 | 51.20 | 74.55 | 79.45 | 74.60 |
| | Number average molecular weight | 20000 | 20000 | 20000 | 26000 | | |
| Component B | wt % | 13.00 | 13.00 | 11.00 | 25.00 | | |
| | Weight average molecular weight | 230000 | 230000 | 230000 | 230000 | | |
| Component C | Resin | SEBS | SEPS | SEPS | | | |
| | wt % | 5.70 | 5.70 | 5.70 | | | |
| Component D | Compatibilizing agent | m-PPE | m-PPE | m-PPE | | m-PP | |
| | wt % | 6.70 | 6.70 | 6.70 | | 20.00 | |
| Component E | wt % | 25.00 | 25.00 | 25.00 | | | 25.00 |
| Additive | Copper(I) iodide | 0.02 | 0.02 | 0.02 | 0.03 | 0.03 | |
| | Potassium iodide | 0.36 | 0.36 | 0.36 | 0.50 | 0.50 | |
| | Melamine resin | 0.02 | 0.02 | 0.02 | 0.02 | 0.02 | |
| Weight ratio A/B | | 79.10/20.90 | 79.10/20.90 | 82.32/17.68 | 75.00/25.00 | 100/0 | 100/0 |
| Weight ratio B/C | | 69.52/30.48 | 69.52/30.48 | 65.87/34.13 | | | |
| Weight ratio (A + B)/D | | 90.28/9.72 | 90.28/9.72 | 90.28/9.72 | | | |
| Weight ratio E/(A + B + C + D) | | 25.10/74.90 | 25.10/74.90 | 25.10/74.90 | | | |
| Dimensional | MD Direction initial shrinkage factor % | 0.28 | 0.29 | 0.30 | 1.07 | 1.65 | 0.30 |
| stability | TD Direction initial shrinkage factor % | 1.05 | 1.07 | 1.08 | 1.42 | 2.20 | 1.55 |
| | Anisotropy (TD/MD) | 3.75 | 3.69 | 3.60 | 1.33 | 1.33 | 5.17 |
| | MD Direction water absorption | 0.12 | 0.12 | 0.13 | 0.58 | 0.65 | 0.16 |
| | dimensional change % | | | | | | |
| | TD Direction water absorption | 0.44 | 0.50 | 0.55 | 0.70 | 0.64 | 0.78 |
| | dimensional change % | | | | | | |

| | | | | | | |
|---|---|---|---|---|---|---|
| Impact resistance (J/m) | 77.00 | 92.00 | 98.00 | 22.00 | 55.00 | 76.00 |
| Limiting PV value (Mpa · cm/sec) | 300 | 400 | 375 | 70 | 50 | 140 |
| Coefficient of dynamic friction | 0.14 | 0.09 | 0.10 | 0.44 | 0.50 | 0.28 |

m-PPE: Fumaric acid-modified polyphenylene ether, m-PP: Modified polypropylene

As is apparent from the results of the measurements shown in Table 1, a shaped article obtained from the polyamide resin composition of the present invention has a small initial shrinkage factor such that the shaped article is prevented from suffering deformation due to warpage, and hence a difference between the dimension of the obtained shaped article and the designed dimension is reduced, making it possible to save energy for the after-processing step for the correction of dimensional difference. That is, in the present invention, there can be provided a polyamide resin composition for sliding part and a sliding part, each being prevented from shrinking both in the MD direction and in the TD direction (having excellent dimensional stability as well as excellent dimensional stability when water is absorbed into the resin) and having excellent impact resistance, a method for producing the sliding part, and a method for producing an automobile using the sliding part.

1. A polyamide resin composition for sliding part, comprising a polyamide resin (component A) and a styrene polymer (component B),
the component B having a deflection temperature under load of 140 to 280° C.,
the weight ratio of the component A to the component B (A/B) being 95/5 to 77/23.

2. The polyamide resin composition for sliding part according to claim 1, wherein the component B is a styrene polymer having a syndiotactic structure.

3. The polyamide resin composition for sliding part according to claim 1, wherein the component A has:
a limiting PV value of 20 to 1,000 MPa·cm/sec,
a coefficient of dynamic friction of 0.001 to 0.7, and
an impact resistance of 20 to 300 J/m.

4. The polyamide resin composition for sliding part according to claim 1, further comprising a thermoplastic resin (component C) obtained by copolymerizing a monomer derived from styrene and a monomer derived from an olefin and/or a monomer derived from a conjugated diene, provided that the component B is excluded from the component C.

5. The polyamide resin composition for sliding part according to claim 1, further comprising at least one compound (component D) selected from the group consisting of a styrene-polyamide block copolymer, a styrene-glycidyl methacrylate copolymer, a styrene-maleic anhydride copolymer, a maleic anhydride-modified styrene block copolymer, a maleic anhydride-modified polyphenylene ether, a maleic anhydride-modified SPS, and a fumaric acid-modified polyphenylene ether, provided that the component B is excluded from the component D.

6. The polyamide resin composition for sliding part according to claim 5, further comprising a glass fiber (component E).

7. The polyamide resin composition for sliding part according to claim 5, wherein:
the component A is present in an amount of 69.45 to 85% by weight,
the component B is present in an amount of 10 to 20% by weight, and
the component D is present in an amount of 5 to 20% by weight, based on 100% by weight of the whole of the components A, B, and D.

8. The polyamide resin composition for sliding part according to claim 6, wherein:
the component A is present in an amount of 50 to 75% by weight,
the component B is present in an amount of 10 to 20% by weight,
the component D is present in an amount of 5 to 10% by weight, and
the component E is present in an amount of 10 to 30% by weight, based on 100% by weight of the whole of the components A, 8, D, and E.

9. The polyamide resin composition for sliding part according to claim 6, wherein:
the component A is present in an amount of (52.09×100/99.59) to 75% by weight,
the component B is present in an amount of 10 to (15.06×100/99.59) % by weight,
the component D is present in an amount of 5 to (7.50×100/99.59) % by weight, and
the component E is present in an amount of 10 to (25.00×100/99.59) % by weight, based on 100% by weight of the whole of the components A, B, D, and E.

10. A sliding part obtainable by shaping the polyamide resin composition for sliding part according to claim 1.

11. The sliding part according to claim 10, which is a gear.

12. The sliding part according to claim 11, which is an electric power steering gear.

13. A method for producing a sliding part, comprising shaping a polyamide resin composition,
the polyamide resin composition having an initial shrinkage factor of 0.2 to 1.2 in the MD direction and an initial shrinkage factor of 1.0 to 1.4 in the TD direction.

14. A method for producing an automobile, comprising incorporating a sliding part obtainable by the method according to claim 13 into a sliding apparatus.

15. The polyamide resin composition for sliding part according to claim 1, further comprising a glass fiber (component E).

16. A sliding part obtainable by shaping the polyamide resin composition for sliding part according to claim 4.

17. A sliding part obtainable by shaping the polyamide resin composition for sliding part according to claim 5.

18. A sliding part obtainable by shaping the polyamide resin composition for sliding part according to claim 6.
